(19) United States
(12) Patent Application Publication
(10) Pub. No.: US 2009/0212141 A1
(43) Pub. Date: Aug. 27, 2009

(54) MILLING APPARATUS

(76) Inventor: Alan Taylor, Warrington (GB)

Correspondence Address: BRACEWELL & GIULIANI LLP, P.O. BOX 61389, HOUSTON, TX, 77208-1389, US

(21) Appl. No.: 11/916,827

(22) PCT Filed: Jun. 2, 2006
(86) PCT No.: PCT/GB2006/001995

§ 371 Date: Jul. 17, 2008

(30) Foreign Application Priority Data
Jun. 8, 2005 (GB) 0511660.3
Feb. 1, 2006 (GB) 0601978.0
Feb. 1, 2006 (GB) 0601980.6

(51) Int. Cl. B02C 19/00; B02C 17/00; B02C 23/10

(52) U.S. Cl. 241/22; 241/172; 241/80

(57) ABSTRACT

A milling apparatus comprising a milling chamber loadable with a grinding charge; an inlet to the milling chamber via which a material to be milled is introduced into the milling chamber; and an outlet from the chamber via which milled material is extracted from the milling chamber; wherein a rotatingly driven centrifuge grinding separator is located within the milling chamber which separator comprises: an upper plate formed with a plurality of diagonally formed through slots; a lower plate formed with a plurality of diagonally formed through slots; and a ring located between the upper and lower plates formed with a plurality of diagonally formed through slots; arranged such that rotation of the central ring formed with the diagonal slots continually pressurizes such a grinding charge so as to force such a grinding charge from the centre of the separator upward and over the periphery of the separator and downward and under en the periphery of the separator and rotation of the upper and lower plates formed with the diagonal slots pulls and draws such a grinding charge back into the centre of the separator.

The present invention relates generally to an apparatus for and a method of milling, wet grinding, mixing, dispersing, emulsifying, homogenizing and similar functions hereinafter referred to as milling.

A milling apparatus is known which comprises a milling chamber for containing particulate material such as granules or beads hereinafter termed the grinding charge. Such a milling apparatus generally comprises an agitating means for submitting this grinding charge and a material to be milled or otherwise treated within the chamber to intense agitating and shearing forces. The agitating means typically comprises one or more impellors or discs that in use cause the material to be milled to flow through the milling chamber and to be submitted to intense agitation and shearing forces in admixture with the grinding charge. In known milling apparatuses a separation device is required to contain the grinding charge so as to separate it from the milled material. Such apparatuses are conventionally referred to as “sand mills”, “agitated bead mills” or “pearl mills” depending on the nature of the grinding charge and or the manufacturer's preference.

According to a first aspect of the present invention there is provided a milling apparatus comprising at least one milling chamber for containing a grinding charge and a material to be milled and within which is located an associated rotatingly driven centrifuge grinding separator which separator comprises:
an upper plate formed with a plurality of diagonally formed through slots;
a lower plate formed with a plurality of diagonally formed through slots; and
a ring located between the upper and lower plates formed with a plurality of diagonally formed through slots;
   arranged such that rotation of the central ring formed with the diagonal slots continually pressurizes such a grinding charge so as to force such a grinding charge from the centre of the separator upward and over the periphery of the separator and downward and under the periphery of the separator and rotation of the upper and lower plates formed with the diagonal slots pulls and draws such a grinding charge back into the centre of the separator.

The grinding chamber of the milling apparatus may comprise an inlet to the milling chamber via which a material to be milled is introduced into the milling chamber; and an outlet from the chamber via which milled material is extracted from the milling chamber.

According to a second aspect of the present invention there is provided a centrifuge grinding separator for a milling machine which separator comprises:
an upper plate formed with a plurality of diagonally formed through slots;
a lower plate formed with a plurality of diagonally formed through slots; and
a ring located between the upper and lower plates formed with a plurality of diagonally formed through slots;
   arranged such that rotation of the central ring within a grinding chamber of a milling machine continually pressurizes a grinding charge so as to force such a grinding charge from the centre of the separator upward and over the periphery of the separator and downward and under the periphery of the separator and rotation of the upper and lower plates formed with the diagonal slots pulls and draws such a grinding charge back into the centre of the separator.

The grinding charge which is drawn back into the centre of the separator is thus caused to separate from the material to be milled within the inner and outer periphery of the centrifuge grinding separator. The milling chamber wall causes the grinding charge to be forced upward and downward at the periphery of the separator and in this way the grinding charge is held in two intense rotating and spiraling collars at the inner and outer periphery of the centrifuge grinding separator. An inlet for the material to be milled causes it to flow directly into the center of the centrifuge grinding separator and the material to be milled is forced into and through the grinding charge by the rotation of the centrifuge grinding separator.

The grinding efficiency may be improved by the action of rotating and stationery pegs. The rotating pegs may be placed at the periphery of the centrifuge grinding separator and the stationery pegs may be held in the upper and lower grinding chamber plates.

The centrifuge grinding separator is a specifically designed rotating element which causes a pre-determined directional movement of the grinding charge, which causes the grinding charge to be captured whilst in motion and held at the periphery of the milling chamber. The centrifuge grinding separator causes the material to be milled, to be subjected to intense agitation, shearing and attrition forces at the same periphery. The capturing of the grinding charge at the periphery of the milling chamber by the rotational force of the centrifuge grinding separator also causes a separation of the grinding charge and material to be milled. No other separation device is required. The milling process may batch or continuous.

The slots in the plates are diagonal in the sense that they are angled with respect to the direction of rotation of the separator. The slots in the lower plate extend from an upper surface of each plate to a lower surface of each plate and are formed so that, in the direction of rotation of the plates, the lower leading edge of each slot precedes the upper leading edge of each slot. The slots in the upper plate extend from an upper surface of the plate to a lower surface of the plate and are formed so that, in the direction of rotation of the plate, the upper leading edge of each slot precedes the lower leading edge of each slot. Thus, the part of the slot on the outer surface of each of the upper an lower plate precedes the part of the slot on the inner surface of each of the upper and lower plates in the direction of rotation of the plates. The slots on the upper and lower plates may be centered on an arc of constant radius from the centre of each plate. Alternatively, the slots on the upper or lower plate may be centered on a line which diverges from such an arc. The slots in the ring are diagonal in the sense that, the through slots extend from the outer surface of the ring to the inner surface of the ring and are formed so that, in the direction of rotation of the ring, the inner leading edge of each slot precedes the outer leading edge of each slot.

According to a third aspect of the present invention there is provided a milling apparatus, in particular for use in wet grinding, comprising at least one milling chamber for containing a grinding charge, a material to be milled and an associated rotatingly driven agitating means, wherein a rotatingly driven containing ring is located adjacent the agitating means, which containing ring is formed with a plurality of through holes angled with respect to the direction of rotation of the ring and configured so as to generate a thrust for containing the grinding charge in the region of the agitating means. Each hole may be angled such that the end of the hole remote from the agitating means precedes the end of that hole proximal to the agitating means in the direction of rotation of the ring. For example, the agitating means may be a centrifuge grinding separator as described above in relation to the first and second aspects of the present invention, although it could also be a more conventional impellor or disc type agitating means.

Where extremely small grinding charge is to be used in a milling apparatus the rotatingly driven containing ring, also called a rotating disc declassifier may be used. The containing ring is designed to cause continual downward thrust to any particulate material, the grinding charge, forcing it back into the main milling chamber, which may be a wet milling chamber. The rotating movement causes a downward thrust, which is generated by the angled holes of the containing ring. The grinding ring is able to work in either vertical or horizontal orientation.

According to a fourth aspect of the present invention, there is provided a milling apparatus, in particular for use in wet grinding, comprising at least one milling chamber for containing a grinding charge, a material to be milled and an associated rotatingly driven agitating means driven by a hollow drive shaft via which milled material is outlet from the milling chamber, wherein a rotatingly driven screen clearing assembly supports an outlet screen over an outlet to the hollow drive shaft and comprises a plurality of arms which extend along an outer surface of the outlet screen, are angled with respect to the direction of rotation of the assembly and are configured so as to generate a thrust for urging the grinding charge outwardly and towards the agitating means. Each arm may be angled such that the end of the arm remote from the agitating means precedes the end of the arm proximal to the agitating means in the direction of rotation of the ring. For example, the agitating means may be a centrifuge grinding separator as described above in relation to the first and second aspects of the present invention, although it could also be a more conventional impellor or disc type agitating means.

Where extremely small grinding charge particles are to be used and the material to be milled is outlet via hollow drive shaft, a milling apparatus may be fitted with such a screen clearing assembly, also called a rotating declassifier. The assembly is designed to cause continual clearing away from the screen, which may be a tubular screen, of any particulates too large to pass through the screen. The rotating movement causes an outward and downward (towards agitating means) thrust, which is generated by the angled arms of the assembly. The assembly is able to work in either a horizontal or vertical orientation.

A embodiments of the invention will now be described by way of example and with reference to the following drawings in which:

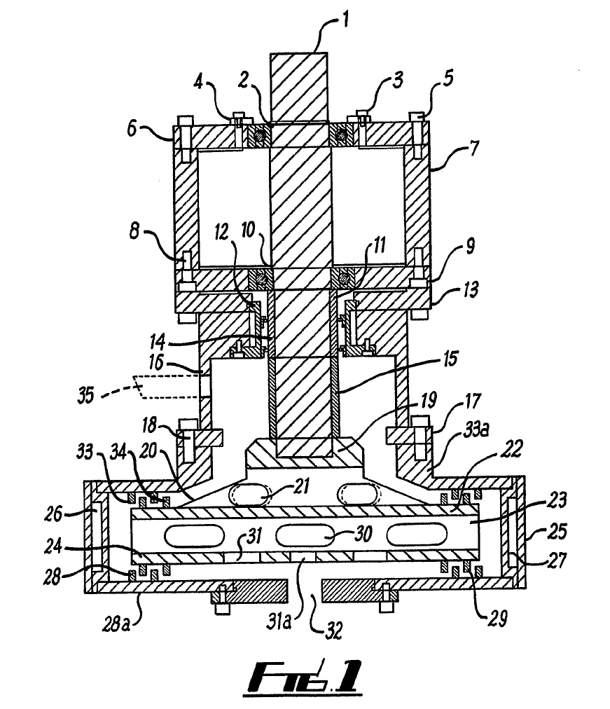

FIG. 1 which shows a milling apparatus according to the present invention in partial cross-section and incorporating a single centrifuge grinding separator located within a single milling chamber;

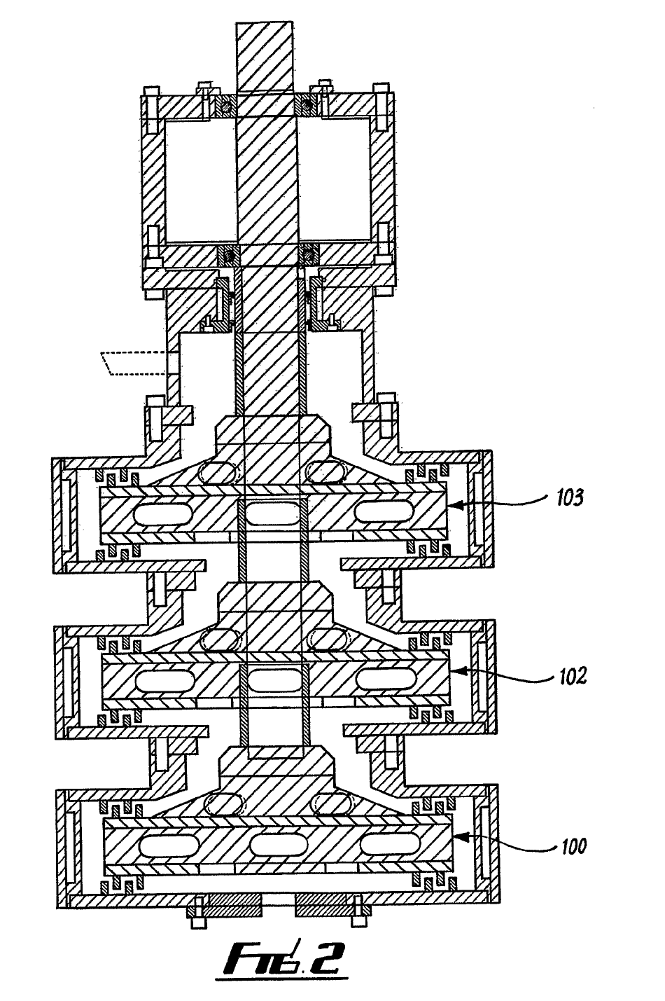

FIG. 2 shows a milling apparatus according to the present invention in partial cross section and incorporating three centrifuge grinding separators within associated milling chambers; and

FIG. 3 shows a side view of the outside of a milling apparatus of FIG. 2;

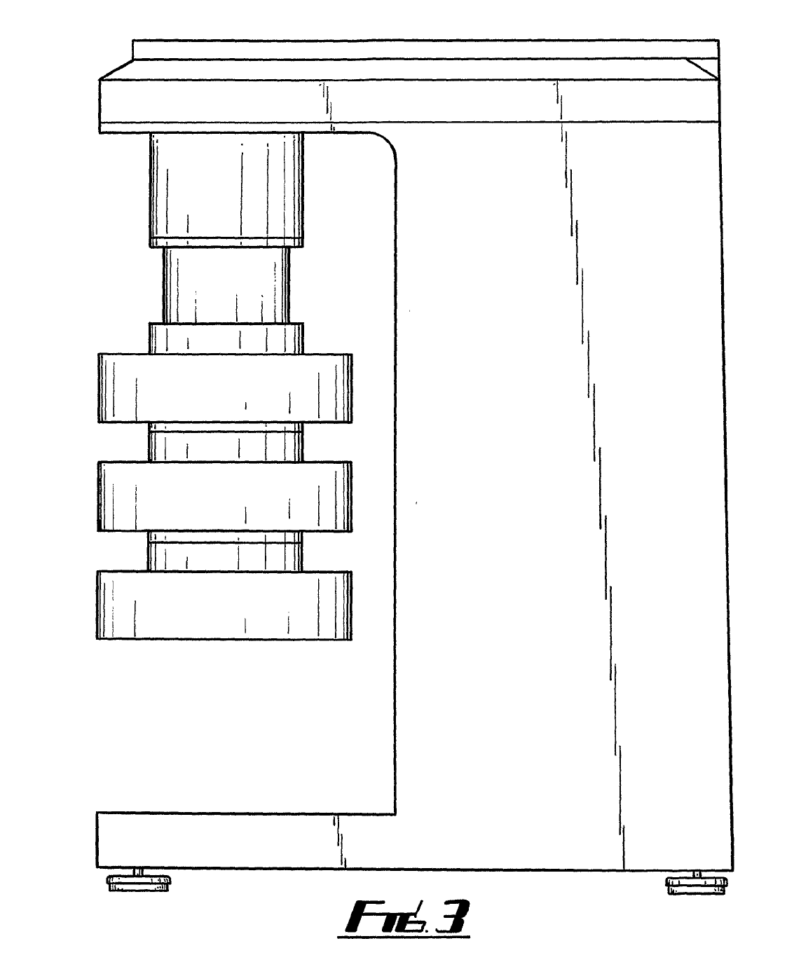

FIG. 4 shows a bottom view of the lower plate of the centrifuge grinding separator;

FIG. 5 shows a plan view of the upper plate of the centrifuge grinding separator;

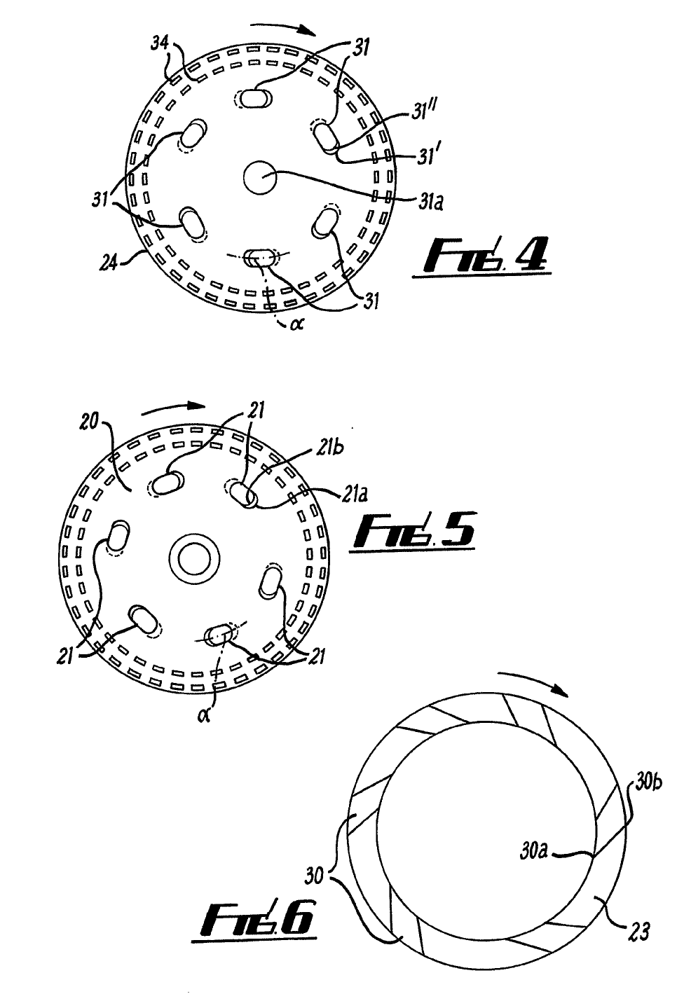

FIG. 6 shows a plan view of the ring of the centrifuge grinding separator;

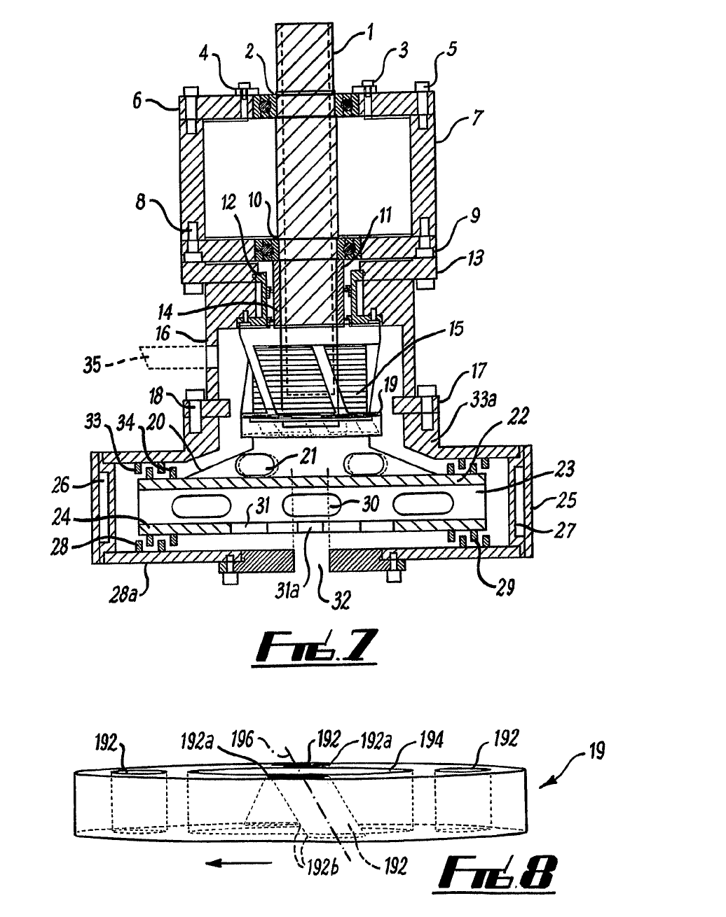

FIG. 7 shows a milling apparatus according to the present invention in partial cross-section and incorporating a single centrifuge grinding separator located within a single milling chamber, also incorporating a containing ring and a screen clearing assembly;

FIG. 8 shows a perspective view of the containing ring of FIG. 7 with the angled through holes shown in dotted lines;

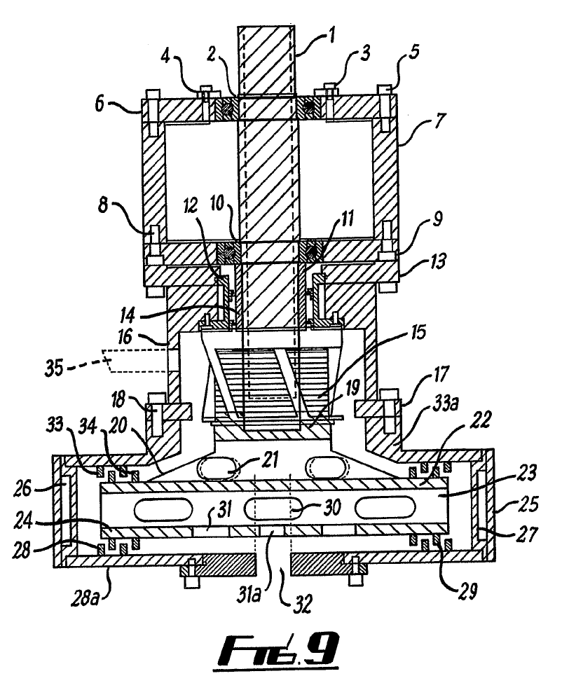

FIG. 9 shows a milling apparatus according to the present invention in partial cross section and incorporating a single centrifuge grinding separator located within a milling chamber and also incorporating a rotatingly driven screen clearing assembly which supports an outlet screen over an outlet to a hollow drive shaft;

FIG. 10 shows a perspective view of the rotatingly driven screen clearing assembly of FIG. 9, not supporting an outlet screen;

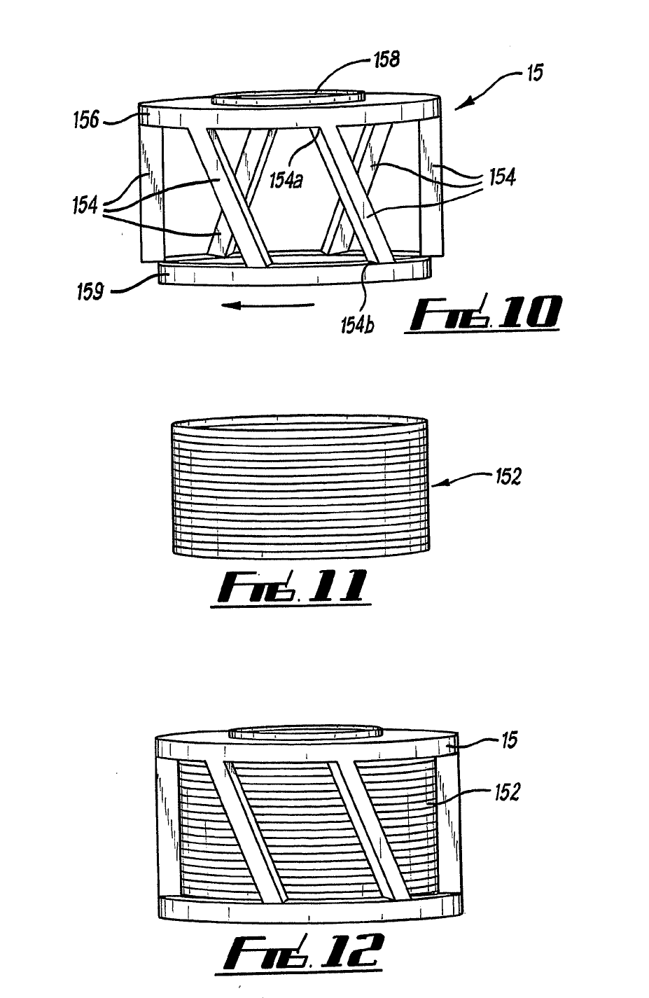

FIG. 11 shows a perspective view of the outlet screen of FIG. 9; and

FIG. 12 shows a perspective view of the rotatingly driven screen clearing assembly of FIG. 10 supporting the outlet screen of FIG. 11.

The milling apparatus shown in the Figure comprises a main drive shaft 1 mounted for use in the vertical orientation secured by a bearing housing 2, 3, 4, 5, 6, 7, 8, 9 and 10.

The shaft 1 is driven by pulleys and belts from a primary drive motor which is single or variable speed in operation (not shown). The shaft 1 carries at its lower end a centrifuge grinding separator 19, 20, 21, 22, 23, 24, 29, 30, 31 and 34. The shaft also passes through a seal housing 11, 12, 13, 14, 15, 16, 17 and 18.

In accordance with the present invention the centrifuge grinding separator comprises three primary sections a slotted an upper rotating plate 20/22, a central rotation ring 23, and a bottom rotating plate 24. The bottom rotating plate 24 carries a number of diagonally formed slots 31 and a single central hole 31a. The top rotating plate has a sloping section 20 which carries a number of diagonally formed slots 21. Fitted to the outer periphery of the centrifuge grinding separator are a number of attrition pegs 29, 34. The central rotation ring 23 carries a number of diagonally formed slots 30. Parts 20, 22, 23, 24, 29 and 34 are assembled to form the centrifuge grinding separator.

The centrifuge grinding separator is secured to the shaft 1 by a number of cap head screws (not shown).

The main milling chamber 27, 28a and 33a is suspended from the seal housing which carries a number of shaft seals 12, and is flushed with liquid via suitable holes (not shown).

The milling chamber is equipped with a number of stationary attrition pegs 28, 33 and a water cooling annulus 26 and jacket 25. In use the milling chamber is partially filled using known technology with a grinding charge of particulate material having a diameter of between 0.1 mm to 3 mm. The material to be milled is caused to flow through the appropriate inlet and outlet ports 32 & 35 respectively and is directed to the very center of the centrifuge grinding separator. At the same time the motor is operated to rotate shaft 1 thereby causing the centrifuge grinding separator to develop the appropriate intense agitation, shearing, attrition and separation conditions within the milling chamber. The rotating centrifuge grinding separator causes the material to be milled to be forced outward and into and through the grinding charge. The escape of the grinding charge is prevented by the separation effect of the centrifuge grinding separator on the material to be milled and the grinding charge. The heavier grinding charge is pulled back into the centrifuge grinding separator by the action of the diagonally formed slots in the upper 20/22 and lower 24 rotating plates.

The milling apparatus described above has several advantages arising from forming the centrifuge grinding separator and grinding chamber as shown.

Improved and intense grinding charge pressure is created between the periphery of the centrifuge grinding separator and grinding chamber wall which results in improved grinding effect.

Lower volume high intensity grinding zones are created.

The grinding zones are maintained throughout the operation by the efficiency of the centrifuge grinding separator causing the grinding charge to behave in a predetermined circular motion and to be concentrated around the inner and outer periphery of the centrifuge grinding separator.

The attrition pegs are so place to cause maximum grinding attrition effect within the inner and outer periphery of the rotating centrifuge grinding separator and the stationary upper and lower milling chamber plates. Aggressive grinding forces are created between the rotating pegs 29, 34 and stationery pegs 28, 33.

A definite separation of the grinding charge from the product to be milled is achieved and so no secondary separation device is required.

As shown in FIGS. 2 and 3 multiple milling chamber and associated centrifuge grinding separator assemblies can be fitted together forming a tiered effect. Each tier has its own grinding zones allowing specific sized grinding charges to be used in each chamber. For example, a grinding charge with a 2 mm diameter may be used in the first assembly 100, a grinding charge with a 1 mm diameter in the second assembly 102 and a grinding charge with a 0.5 mm diameter in the third assembly 103. Effectively, the one milling apparatus of FIGS. 2 and 3 has three separate milling and separation zones. The material to be milled passes through assembly 100, through assembly 102, and finally through assembly 103.

Lower grinding charge volumes are to be used.

Smaller particle size reduction is achieved on the material to be milled giving very fine particle products.

Temperature control of material to be milled is achieved by preset temperature limitations through a micro-processor so as to control the input speed through variable speed drive.

A range of mill sizes with good relative dimensions is set out in the following Example.

### EXAMPLE

### Production Models Laboratory Model

### Small Medium Large

Motor speed (rpm) 300 1500 1000 750 & variable, Chamber volume (litres) 0.25 through to 50 (litres).

The milling apparatus according to the present invention is a grinding machine, such as a wet grinding machine which is comprised of a main drive shaft supported by a bearing/seal housing which is driven by V Belts and pulleys via a primary electric motor. The grinding chamber is suspended from the seal housing in a vertical configuration which is wide and shallow. Suspended at the lower end of the main drive shaft are the main rotational elements (centrifuge grinding separator). Within the grinding chamber, particulate grinding materials are housed. The material to be milled is passed through a suitable inlet 32 and is dispersed through the grinding charge before leaving the machine via a suitable outlet 35 in continuous operation. The material to be milled and the grinding charge are separated at the periphery of the centrifuge grinding separator. No other separation devise is required.

FIGS. 4 to 6 show the orientation of the diagonal slots through the lower plate, the upper plate and the ring of the centrifuge grinding separator, with respect to the clockwise direction of rotation of the separator, which is shown by the arrows in the Figures. The diagonal slots are angled with respect to the direction of rotation of the separator.

FIG. 4 shows a bottom view of the underneath of the lower plate 24 and from this it can be seen that the diagonal slots 31 are formed from the bottom of the lower plate to the top of the lower plate such that the part of the slot at the bottom of the lower plate (shown in full lines) precedes the part of the slot at the top of the lower plate (shown partially in dotted lines) in the direction of rotation of the lower plate 24. As can be seen from FIG. 4, the lower leading edge 31′ of each slot precedes the upper leading edge 31″ of each slot. The slots are centered on and extend along an arc α the points on which are all equidistant from the centre of the plate 24. This need not be the case and the slots can be formed so that they diverge from such an arc α, either towards the direction of the edge of the plate 24 or towards the centre of the plate 24.

FIG. 5 shows a top or plan view of the upper plate 20 and from this it can be seen that the diagonal slots 21 are formed from the bottom of the upper plate to the top of the upper plate such that the part of the slot at the top of the upper plate (shown in full lines) precedes the part of the slot at the bottom of the upper plate (shown partially in dotted lines) in the direction of rotation of the upper plate 20. As can be seen from FIG. 5, the upper leading edge 21a of each slot precedes the lower leading edge 21b of each slot. The slots are centered on and extend along an arc α, the points on which are all equidistant from the centre of the plate 20. This need not be the case and the slots can be formed so that they diverge from such an arc α, either towards the direction of the edge of the plate 20 or towards the centre of the plate 20.

It can be seen from FIGS. 4 and 5 that when the separator is assembled, for each of the through slots, the part of the slot on the outer surface the upper or lower plate precedes the part of the slot on the inner surface of that plate in the direction of rotation of the plates.

FIG. 6 shows a plan view of the ring 23 and from this it can be seen that the diagonal slots 30 are formed in the ring from the outer surface of the ring to the inner surface of the ring such that the part of the slot at the inner surface of the ring precedes the part of the slot at the outer surface of the ring in the direction of rotation of the ring 23. The inner leading edge 30a of each slot precedes the outer leading edge 30b of each slot. It can be seen that the slots extend at an angle to a radius of the ring 23.

FIG. 7 shows a milling apparatus of the type described above in relation to FIGS. 1 to 7 with like parts referenced by like numerals. However, in FIG. 7, the drive shaft 1 is shown hollow and the milled material leaves the milling chamber via an outlet into the hollow drive shaft. In addition the FIG. 7 incorporates a containing ring 19 which is rotatingly driven at the lower end of the drive shaft 1 (shown in more detail in FIG. 8). The containing ring 19 is located above the upper plate 20 of the centrifuge grinding separator. The containing ring 19 is designed to cause a continual downward thrust to the grinding charge, forcing it back into the main milling chamber, ie. back towards the centrifuge grinding separator. The downward thrust generated by the rotation of the containing ring 19 is caused by the angled holes 192 of the containing ring.

The containing ring 19 comprises a specifically designed round flat disc (see FIG. 8) with a centrally placed hole 194 suitable to cause an easy fit onto a driven shaft. The containing ring 19 is located onto a drive shaft and is situated between other rotating components. The rotating disc of the containing ring 19 is made with angularly drilled holes 192 around its periphery. The rotational movement of the grinding ring 19 causes a downward force to be exerted on any particulate material being in close proximity to the outlet of the milling chamber. The rotational movement of the grinding ring causes any particulate material moving towards the immediate area of the outlet of the grinding chamber to be moved down and away from this area and back into the main milling chamber.

The through holes 192 in the containing ring 19 extend from a lower surface of the ring (facing towards the centrifugal grinding separator) to an upper surface of the ring (facing generally towards the outlet 35 of the milling chamber). The through holes are each centred on a line 196, which line extends at an angle to a line parallel to the axis of the drive shaft 1. As can be seen from FIG. 8, the upper part of each hole 192 (remote from the agitating means) precedes the lower part of each hole (proximal to the agitating means) as the ring 19 rotates in the direction shown by the arrow. Thus, for each hole the leading edge 192a of the upper part of the hole 192 precedes the leading edge 192b of the lower part of the hole 192, in the direction of rotation.

FIG. 9 shows a milling apparatus of the type described above in relation to FIGS. 1 to 7 with like parts referenced by like numerals. The drive shaft 1 is hollow and the milled material leaves the milling chamber via an outlet into the hollow drive shaft. In addition the FIG. 9 incorporates a rotatingly driven screen clearing assembly 15 which is shown in more detail in FIGS. 10 to 12. The assembly 15 supports an outlet screen 152 over an outlet to the hollow drive shaft and comprises a plurality of angled arms 154 which extend along an outer surface of the outlet screen 152 and are configured so as to generate a thrust for urging the grinding charge outwardly and towards the centrifuge grinding separator. The assembly 15 comprises a specifically designed tubular framework so designed as to have an upper supporting ring 156 (see FIGS. 10 to 12) with a centrally placed hole 158 suitable to cause an easy fit onto a drive shaft and a lower ring 159. Extending from the upper ring 156 are a plurality of angular arms 154 separated by spaces or slots, which arms terminate at the lower supporting ring 159. The central bore of the assembly 15 is machined to accept a closely fitting tubular screen device 152 (see FIGS. 11 and 12). The tubular screen device is not claimed as proprietary. The assembly 15 fitted with the screen 152 is located on a drive shaft 1 and is situated between other rotating components. The outlet screen 152 may be formed with slots of varying width. The rotational movement of the assembly causes an outward and downward force to any particulate matter, such as grinding charge, in close proximity with the tubular screening device 152. The force causes any particulate material to be moved down and away from the assembly 15 and back into the proximity of the centrifuge grinding separator.

The arms 154 are angled with respect to the direction of rotation (shown by the arrow in FIG. 10) of the assembly 15. For each arm 154, the upper leading edge 154a (remote from the separator) of the arm precedes the lower leading edge 154b (proximal to the separator) of the arm.

The angular arms 154 are angled so that the lower part of each arm (proximal to the centrifuge grinding separator) precedes the upper part of each arm (remote from the centrifuge grinding separator) in the clockwise direction of rotation as shown by the arrow in FIG. 10.

1. A milling apparatus comprising at least one milling chamber for containing a grinding charge and a material to be milled, within which is located an associated rotatingly driven centrifuge grinding separator, which separator comprises:
an upper plate formed with a plurality of diagonally formed through slots;
a lower plate formed with a plurality of diagonally formed through slots; and
a ring located between the upper and lower plates formed with a plurality of diagonally formed through slots;
arranged such that rotation of the central ring formed with the diagonal slots continually pressurizes such a grinding charge so as to force such a grinding charge from the centre of the centrifuge grinding separator upward and over the periphery of the separator and downward and under the periphery of the separator and rotation of the upper and lower plates formed with the diagonal slots pulls and draws such a grinding charge back into the centre of the separator.

2. An apparatus according to claim 1 wherein the upper surface of the upper plate has a sloping section which extends upwardly towards the centre of the plate and which carries the plurality of diagonally formed slots.

3. A milling apparatus according to claim 1 additionally comprising:
an inlet to the milling chamber via which a material to be milled is introduced into the milling chamber; and
wherein the inlet is positioned so as to cause a material to be milled to flow directly into the centre of the centrifuge grinding separator.

4. (canceled)

5. A milling apparatus according claim 4 wherein the lower plate is formed with a central hole via which a material to be milled flows from the inlet into the centre of the centrifuge grinding separator.

6. A milling apparatus according to claim 1 wherein the ring extends between the periphery of the upper plate and the periphery of the lower plate.

7. A milling apparatus according to claim 1 wherein a set of rotating attrition pegs is located on the periphery of the separator so as to rotate with the separator and a set of stationary attrition pegs is located in the grinding chamber in a facing arrangement with the rotating attrition pegs.

8. A milling apparatus according to claim 1 additionally comprising a drive shaft wherein the drive shaft rotatingly drives the centrifuge grinding separator and a drive motor wherein the motor rotatingly drives the drive shaft, wherein the motor is a variable speed motor and the apparatus additionally comprises a micro-processor for controlling the speed of the motor wherein temperature control of the material to be milled is achieved by varying the speed of the motor to maintain the temperature below a preset temperature limitation.

9. (canceled)

10. A milling apparatus according to claim 1 comprising a tiered arrangement of multiple milling chambers and associated centrifuge grinding separators through which the material to be milled passes sequentially.

11. A milling apparatus according to claim 10 wherein each successive milling chamber in the sequence is filled with grinding charges having progressively smaller diameters.

12. A milling apparatus according to claim 1 wherein the through slots in the upper and lower plates extend from an outer surface of each plate to an inner surface of each plate and are formed so that, in the direction of rotation of the plates, the outer leading edge of each slot precedes the inner leading edge of that slot.

13. A milling apparatus according to claim 1 wherein the through slots in the ring extend from the outer surface of the ring to the inner surface of the ring and are formed so that, in the direction of rotation of the ring, the inner leading edge of each slot precedes the outer leading edge of that slot.

14. A centrifuge grinding separator for a milling machine which separator comprises:
an upper plate formed with a plurality of diagonally formed through slots;
a lower plate formed with a plurality of diagonally formed through slots; and
a ring located between the upper and lower plates formed with a plurality of diagonally formed through slots;
arranged such that rotation of the central ring within a grinding chamber of a milling machine continually pressurizes a grinding charge so as to force such a grinding charge from the centre of the grinding charge separator upward and over the periphery of the separator and downward and under the periphery of the separator and rotation of the upper and lower plates formed with the diagonal slots pulls and draws such a grinding charge back into the centre of the separator.

15. A method of milling using a milling apparatus according to claim 1 comprising the steps of:
loading the grinding chamber with a grinding charge;
introducing a material to be milled into the grinding chamber; and
rotatingly driving the centrifuge grinding separator.

16. A milling apparatus according to claim 1 wherein a rotatingly driven containing ring is located adjacent the centrifuge grinding separator, which containing ring is formed with a plurality of through holes angled with respect to the direction of rotation of the ring and configured so as to generate a thrust for containing such a grinding charge in the region of the centrifuge grinding separator.

17. (canceled)

18. A milling apparatus according to claim 16 wherein the containing ring is located between the centrifuge grinding separator and an outlet of the grinding chamber and the thrust directs the grinding charge away from the immediate area of the outlet.

19. A milling apparatus according to claim 16 wherein the containing ring comprises a round flat disc with a centrally placed hole and the angled holes extend from an upper to a lower surface of the disc.

20. (canceled)

21. A milling apparatus according to claim 1 wherein the centrifuge grinding separator is driven by a hollow drive shaft via which a milled material is outlet from the milling chamber, wherein a rotatingly driven screen clearing assembly supports an outlet screen over an outlet to the hollow drive shaft and comprises a plurality of arms which extend along an outer surface of the outlet screen, are angled with respect to the direction of rotation of the assembly and are configured so as to generate a thrust for urging such a grinding charge outwardly and towards the agitating means.

22. (canceled)

23. A milling apparatus according to claim 21 wherein the outlet screen is tubular.

24. A milling apparatus according to claim 21 wherein the assembly comprises a tubular frame having an upper supporting ring and a lower supporting ring and the plurality of arms extend from the upper ring and terminate at the lower supporting ring.

25. A milling apparatus according to claim 21 wherein the angular arms of the assembly are angled so that the lower part of each arm (proximal to the centrifuge grinding separator) trails the upper part of each arm (remote from the centrifuge grinding separator) in the direction of rotation of the assembly,

26. (canceled)
